(19) United States
(12) Patent Application Publication
(10) Pub. No.: US 2013/0127746 A1
(43) Pub. Date: May 23, 2013

(54) METHOD FOR CONTROLLING TOUCH PANEL

(71) Applicant: Yun-Hsiang Yeh, Hsinchu County (TW)

(72) Inventor: Yun-Hsiang Yeh, Hsinchu County (TW)

(73) Assignee: NOVATEK MICROELECTRONICS CORP., Hsinchu (TW)

(21) Appl. No.: 13/548,167

(22) Filed: Jul. 12, 2012

(30) Foreign Application Priority Data
Nov. 17, 2011 (TW) 100142015

(51) Int. Cl. G06F 3/041

(52) U.S. Cl. 345/173

(57) ABSTRACT

A method for controlling a touch panel is provided. A touch control device has a control circuit and the touch panel. The control circuit first detects a touched point within an entire detection area on the touch panel until a first touched point is detected within the entire detection area. After detecting the first touched point, the control circuit narrows a range of detecting the touched point on the touch panel, so as to detect the touched point within a local detection area on the touch panel. The entire detection area includes and is greater than the local detection area. Accordingly, the time for detecting the touched point can be reduced, and the speed of detecting the touched point can be increased.

### CROSS-REFERENCE TO RELATED APPLICATION

This application claims the priority benefit of Taiwan application serial no. 100142015, filed on Nov. 17, 2011. The entirety of the above-mentioned patent application is hereby incorporated by reference herein and made a part of this specification.

### BACKGROUND OF THE INVENTION

1. Field of the Invention

The present invention relates to a method for controlling a touch panel, and more particularly to a method for controlling a touch panel capable of enhancing an efficiency of detecting touched point.

2. Description of Related Art

In the current information era, people become increasingly dependent on electronic products. The electronic products such as a notebook computer, a mobile phone, a personal digital assistant (PDA), a digital walkman are already become essential application tools in the lives of modern people. All the electronic products have an input interface for a user to input an instruction so that an internal system of the electronic product to automatically execute the instruction.

To provide a more user-friendly operational mode, manufacturers start to dispose an input interface such as a touch pad or a touch panel on an electronic device to enable a user to input an instruction through the touch pad or touch panel. Generally speaking, the commercially available touch control device includes, for example, a resistive touch control device and a capacitive touch control device. The sensing units on the touch control device are arranged on a two-dimensional plane in a matrix manner and a touched point is detected according to a scan signal. However, as a conventional method of detecting a touched point is to find a touched point by using all scan channels of the touch panel, when too many scan channels exist, the efficiency of scanning a touched point is also accordingly reduced.

### SUMMARY OF THE INVENTION

The present invention is directed to a method for controlling a touch panel capable of enhancing an efficiency of detecting a touched point.

The present invention provides a method for controlling a touch panel. The method comprises: detecting a touched point within an entire detection area on the touch panel, until a first touched point is detected within the entire area. The method further comprises: after the first touched point is detected, narrowing a range of detecting the touched point on the touch panel, so as to detect the touched point within a local detection area on the touch panel. The entire detection area comprises and is greater than the local detection area.

The present invention provides a method for controlling a touch panel. The method comprises: detecting touched points within an entire detection area on the touch panel, until a first touched point and a second touched point is detected within the entire area. The method further comprises: after the first touched point and the second touched point are detected, narrowing ranges of detecting the touched points on the touch panel, so as to detect the touched points within the first local detection area and the second local detection area on the touch panel. The entire detection area comprises and is greater than the first local detection area and the second local detection area.

In an embodiment of the present invention, the touch panel has a plurality of first channels and a plurality of second channels. The plurality of first channels interlace with the plurality of second channels. When a touched point is being detected within the entire detection area, the first touched point is detected through all the first channels and all the second channels. When the touched point within the local detection area is being detected, the touched point on the touch panel is detected through a part of the first channels and a part of the second channels adjacent to the first touched point.

In an embodiment of the present invention, the touch panel has a plurality of first channels and a plurality of second channels. The plurality of first channels interlace with the plurality of second channels. When a touched point within an entire detection area is being detected, it is first determined whether the touch panel is touched or not through all the first channels, and then determined whether the touch panel is touched or not through all the second channels, so as to detect the first touched point. When a touched point within the local detection area is being detected, the touched point on the touch panel is detected through a part of the first channels and a part of the second channels adjacent to the first touched point.

In an embodiment of the present invention, the touch panel has a plurality of first channels and a plurality of second channels. The plurality of first channels interlace with the plurality of second channels. When touched point within an entire detection area are being detected, it is determined whether the touch panel is touched or not through a first group of the first channels, a second group of the first channels, and all the second channels in sequence, so as to detect the first touched point. The first channels in the first group are parallel to and interleaved with the first channels in the second group. When touched points within a local detection area are being detected, the touched points on the touch panel are detected through a part of the first channels and a part of the second channels adjacent to the first touched point.

In an embodiment of the present invention, the first channels in the first group are even-numbered channels in the first channel and the first channels in the second group are odd-numbered channels in the first channel.

In an embodiment of the present invention, the first channels in the first group are odd-numbered channels in the first channel and the first channels in the second group are even-numbered channels in the first channel.

In an embodiment of the present invention, the first touched point is located within the local detection area.

In an embodiment of the present invention, the touch panel has a plurality of first channels and a plurality of second channels. The plurality of first channels interlace with the plurality of second channels. A used density of the first channels and second channels within an entire detection area is smaller than a used density of the first channels and second channels within the local detection area.

In an embodiment of the present invention, the first touched point is located within the first local detection area and the second touched point is located within the second local detection area.

In an embodiment of the present invention, the touch panel has a plurality of first channels and a plurality of second channels. The plurality of first channels interlace with the plurality of second channels. A used density of the plurality of first channels and the plurality of second channels within an entire detection area is smaller than used densities of the plurality of first channels and the plurality of second channels within the first local detection area and the second local detection area.

In an embodiment of the present invention, when the touched points within the first local detection area and the second local detection area are being detected, the touched points on the touch panel are detected through a part of the first channels and a part of the second channels adjacent to the first touched point and the second touched point.

In an embodiment of the present invention, the method further comprises: when the accumulated number of times of detecting the touched points within the first local detection area and the second local detection area is equal to a preset number of times, it is confirmed whether a new touched point occurs within the entire detection area by detecting the entire area.

Based on the above, in the present invention, after the first touched point is detected, a range of detecting the touched point on the touch panel is narrowed, so as to detect the touched point within a local detection area on the touch panel. Accordingly, when a touched point on the touch panel is being detected in an area detection manner, the number of used channels can be reduced, so as to enhance the efficiency of detecting a touched point.

In order to make the aforementioned and other objectives and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a touch control device according to an embodiment of the present invention.

FIG. 2 is a schematic diagram of a touch panel in FIG. 1.

FIG. 3 is a schematic diagram of first channels of the touch panel in FIG. 2.

FIG. 4 is a schematic diagram of second channels of touch panels in FIG. 2.

FIG. 5 illustrates a method for controlling a touch panel according to an embodiment of the present invention.

FIG. 6 is a flow chart of a method for controlling a touch panel according to an embodiment of the present invention.

FIG. 7 is a flow chart of a method for controlling a touch panel according to an embodiment of the present invention.

FIG. 8 is a flow chart of a method for controlling a touch panel according to an embodiment of the present invention.

FIG. 9 illustrates a method for controlling a touch panel according to an embodiment of the present invention.

FIG. 10 is a flow chart of a method for controlling a touch panel according to an embodiment of the present invention.

FIG. 11 is a schematic diagram of a method for controlling a touch panel according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

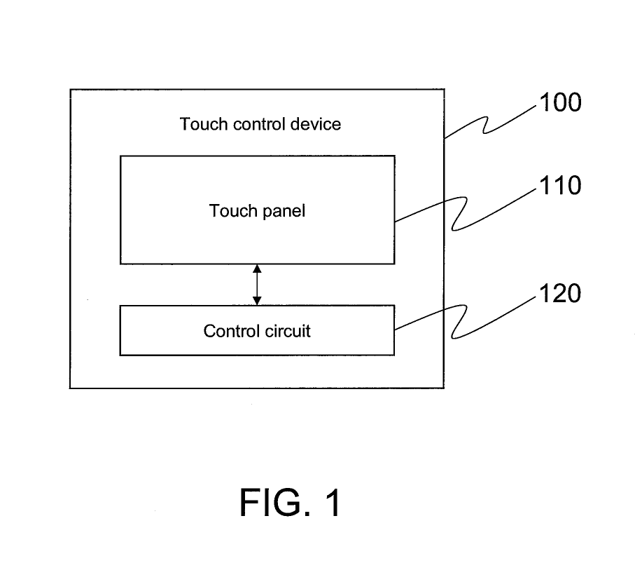

Please refer to FIG. 1. FIG. 1 is a functional block diagram of a touch control device 100 according to an embodiment of the present invention. The touch control device 100 has a touch panel 110 and a control circuit 120. The touch panel 110 may be a resistive touch panel or a capacitive touch panel. When the touch panel 110 is a capacitive touch panel, the touch panel 110 may further be a self capacitance touch panel or a mutual capacitance touch panel. The touch panel 110 generates and outputs a corresponding signal due to a touch situation. Generally speaking, a signal output by the touch panel 110 may reflect information such as a touch position and force. The control circuit 120 is coupled to the touch panel 110 and used for, based on the signal output by the touch panel 110, determining a touched position of the touch panel 110, so as to further generate a corresponding coordinate signal and/or control signal.

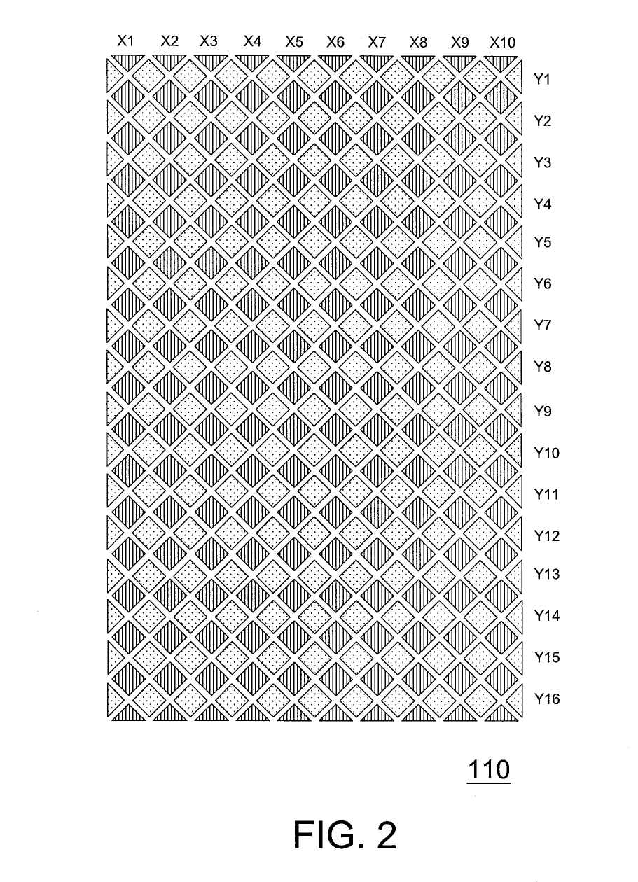

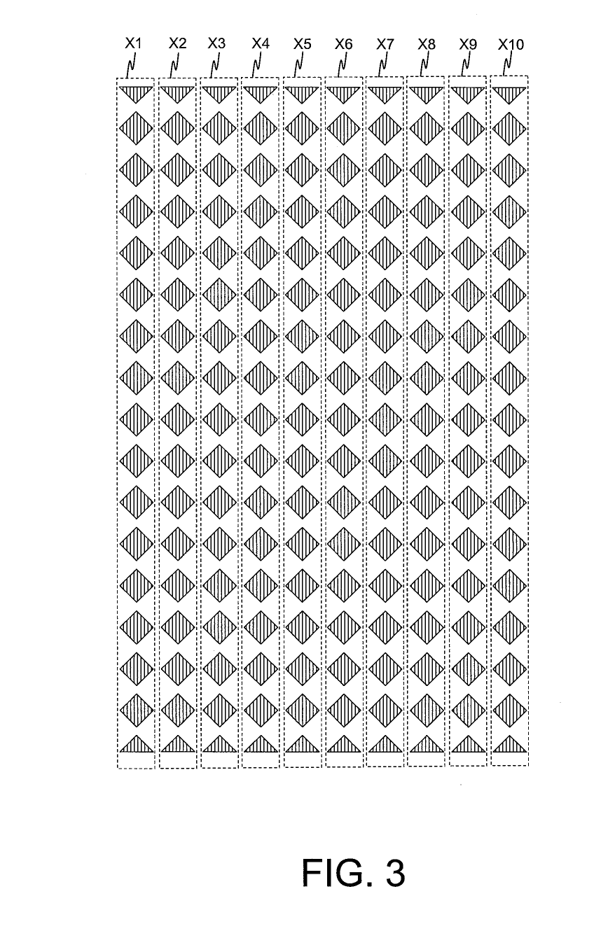

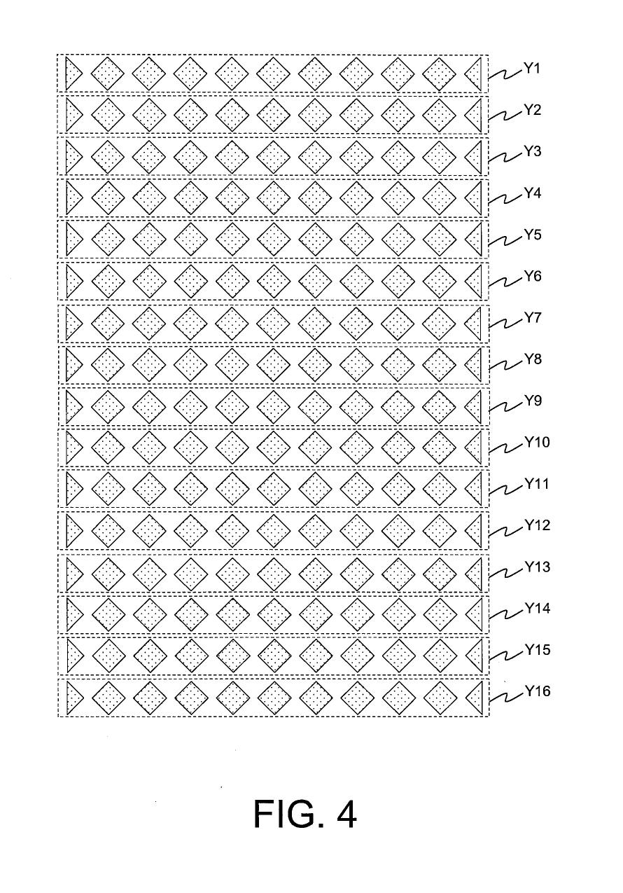

Please refer to FIG. 2 to FIG. 4. FIG. 2 is a schematic diagram of the touch panel 110 in FIG. 1. FIG. 3 is a schematic diagram of first channels X1 to X10 of the touch panel 110 in FIG. 2. FIG. 4 is a schematic diagram of second channels Y1 to Y16 of the touch panel 110 in FIG. 2. The touch panel 110 has a plurality of first channels X1 to X10 and a plurality of second channels Y1 to Y16. The first channels X1 to X10 interlace with the plurality of second channels Y1 to Y16. The first channels X1 to X10 are parallel to each other. The second channels Y1 to Y16 are parallel to each other. It should be understood that although in the touch panel 110 in this embodiment, the number of the first channels is 10 and the number of the second channels is 16, the present invention is not limited thereto. Persons of ordinary skill in the art should understand that the first channels and the second channels of the touch panel may also be other numbers.

The first channels X1 to X10 and the second channels Y1 to Y16 are used for decide a touched point on the touch panel 110. In particular, when the touch panel 110 is touched, relevant electrical characteristics (for example, resistance or capacitance) of a touched point change accordingly, so through the first channels X1 to X10 and the second channels Y1 to Y16, two-dimensional coordinates of the touched point on the touch panel 110 can be decided. In an embodiment of the present invention, the control circuit 120 turns on the first channels X1 to X10 and the second channels Y1 to Y16 in sequence to detect electrical characteristics of all channels. When any channel among the first channels X1 to X10 and the second channels Y1 to Y16 is turned on, the control circuit 120 calculates electrical characteristics (for example, resistance or capacitance) of the channel that is turned on by detecting a signal generated by the channel that is turned on and determines whether the touched point of the touch panel 110 is located on the channel that is turned on based on the calculated electrical characteristics. In such a manner, the control circuit 120 then can determine the touched point on the touch panel 110 by turning on the first channels X1 to X10 and the second channels Y1 to Y16.

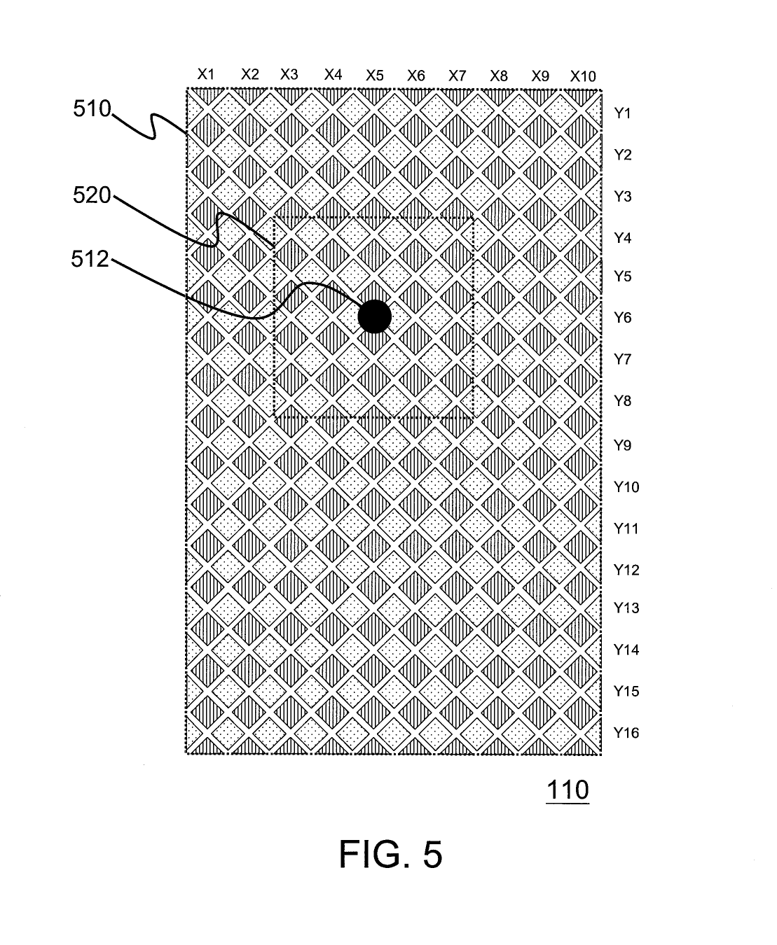

In an embodiment of the present invention, the control circuit 120 first detects the touched point on the touch panel 110 in an entire detection manner, until a first touched point is detected on the touch panel 110. After the control circuit 120 detects the first touched point, the control circuit 120 switches to an area detection manner to detect the touched point on the touch panel 110. Please refer to FIG. 1 and FIG. 5. FIG. 5 illustrates a method for controlling the touch panel 110 according to an embodiment of the present invention. First, when the control circuit 120 detects the touched point on the touch panel 110 in an entire detection manner, the control circuit 120 utilizes the first channels X1 to X10 and the second channels Y1 to Y16 to determine the touched point on the touch panel 110. In other words, at this time, the control circuit 120 turns on the first channels X1 to X10 and the second channels Y1 to Y16 in sequence, until a first touched point 512 on the touch panel 110 is detected. After the control circuit 120 detects the first touched point 512, the control circuit 120 switches to an area detection manner to detect the touched point on the touch panel 110. That is, the control circuit 120 only utilizes a part of the first channels and a part of the second channels to detect the touched point on the touch panel 110. In this embodiment, when the control circuit 120 detects the touched point on the touch panel 110 in an entire detection manner, the control circuit 120 detects the touched point on the touch panel 110 within the entire detection area 510. When the control circuit 120 detects the touched point on the touch panel 110 in an area detection manner, the control circuit 120 detects the touched point on the touch panel 110 within a first local detection area 520, the first touched point 512 is located within the first local detection area 520, and the entire detection area 510 comprises and is greater than first local detection area 520. In other words, after the first touched point 512 is detected, the control circuit 120 narrows a range of detecting the touched point on the touch panel 110, so that the detection area changes from the original first entire detection area 510 into the subsequent first local detection area 520.

In an embodiment of the present invention, the range of the first local detection area 520 may be decided based on the first touched point 512. Taking FIG. 5 as an example, a position of the first touched point 512 is near a position where the first channel X5 and the second channel Y6 interlace with each other. The first local detection area 520 takes the first touched point 512 as a center and the range thereof is an area defined by the first channels X3 to X7 and second channels Y4 to Y8. Furthermore, after the control circuit 120 detects the first touched point 512, the control circuit 120 locally detects the touched point on the touch panel 110 within the first local detection area 520 through the first channels X3 to X7 and the second channels Y4 to Y8.

As can be seen from the illustration, in the present invention, the control circuit 120 first detects a touched point within the entire detection area 510 on the touch panel 110, until the first touched point 512 is detected within the entire area 510. After the first touched point 512 is detected, the control circuit 120 narrows a range of detecting the touched point on the touch panel 110, so as to detect the touched point within the first local detection area 520 on the touch panel 110. As the control circuit 120, when detecting the touched point within the first local detection area 520, does not need to turn on all the first channels X1 to X10 and the second channels Y1 to Y16 in sequence, and only needs to turn on a part of the first channels and second channels, so the efficiency of detecting the touched point on the touch panel 110 can be enhanced.

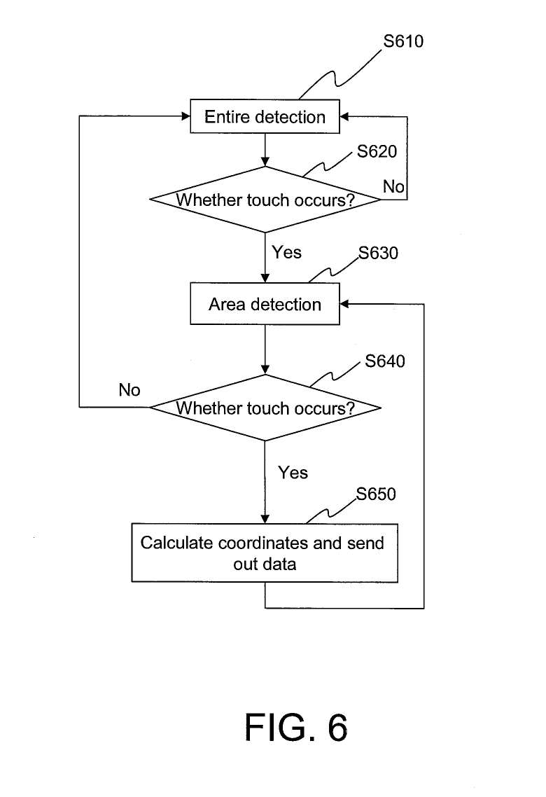

Please refer to FIG. 6, FIG. 1, and FIG. 5. FIG. 6 is a flow chart of a method for controlling a touch panel 110 according to an embodiment of the present invention. In Step S610, the control circuit 120 detects a touched point on the touch panel 110 in an entire detection manner, that is, detects the touched point on the touch panel 110 within the entire detection area 510. In Step S620, the control circuit 120 determines whether the touch panel 110 is touched or not. If in Step S620, the touch panel 110 is not touched, the process returns to Step S610. Otherwise, if the control circuit 120 determines that the touch panel 110 is touched (for example, the touched point is the first touched point 512), Step S630 is performed. In Step 630, the control circuit 120 switches to an area detection manner to detect the touched point on the touch panel 110. At this time, the control circuit 120 detects the touched point on the touch panel 110 within the first local detection area 520. In Step S640, the control circuit 120 determines whether the touch panel 110 is touched. If in Step S640, the touch panel 110 is not touched, the process returns to Step S610. Otherwise, if the control circuit 120 determines that the touch panel 110 is touched, Step S650 is performed, so as to calculate coordinates of the touched point and send out the data.

In an embodiment of the present invention, the action of Step S650 may also be otherwise executed between Steps S620 and S630, so that in the process that the control circuit 120 switches a detection manner from the entire detection manner to the area detection manner, Step S650 is executed once first, so as to calculate the coordinates of the first touched point 512 and send out relevant data.

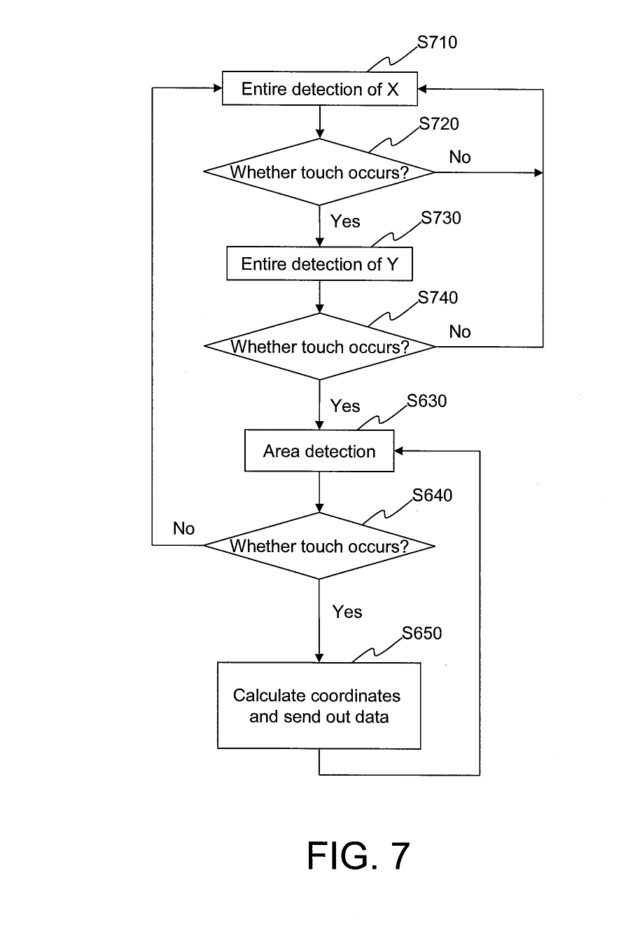

Please refer to FIG. 7, FIG. 1, and FIG. 5. FIG. 7 is a flow chart of a method for controlling a touch panel 110 according to another embodiment of the present invention. The difference between the process in FIG. 7 and the process in FIG. 6 is the entire detection manner of the control circuit 120. In the process in FIG. 7, the control circuit 120 finishes detecting the touched point on the touch panel 110 in the entire detection manner through Steps S710 to S740. In Step S710, the control circuit 120 first performs entire detection of X, that is, the control circuit 120 detects signals of the first channels X1 to X10 in sequence. Subsequently, in Step S720, the control circuit 120 determines whether the touch panel 110 is touched or not based on the signals of the first channels X1 to X10. Next, in Step S730, the control circuit 120 performs entire detection of Y, that is, the control circuit 120 detects the signals of the second channels Y1 to Y16 in sequence. Subsequently, in Step S740, the control circuit 120 determines whether the touch panel 110 is touched based on the signals of the second channels Y1 to Y16. In other words, in this embodiment, when the control circuit 120 detects the touched point on the touch panel 110 in the entire detection manner, the control circuit 120 first determines whether the touch panel 110 is touched or not through all the first channels X1 to X10, and then determines whether the touch panel 110 is touched through all the second channels Y1 to Y16, so as to detect the first touched point 512. Subsequently, the control circuit 120 finishes detecting the touched point on the touch panel 110 in an area detection manner through Steps S630 to S650. In this embodiment, when the control circuit 120 detects the touched point on the touch panel 110 in the area detection manner, the control circuit 120 detects the touched point on the touch panel 110 through a part of the first channels adjacent to the first touched point 512 (for example, the first channels X3 to X7) and a part of the second channels adjacent to the first touched point 512 (for example, the second channels Y4 to Y8).

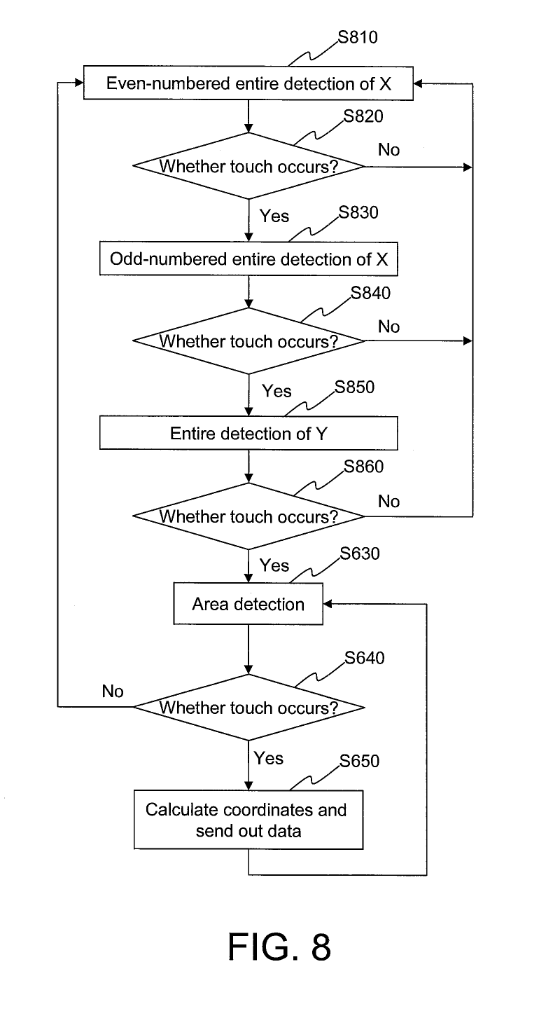

Please refer to FIG. 8, FIG. 1, and FIG. 5. FIG. 8 is a flow chart of a method for controlling a touch panel 110 according to another embodiment of the present invention. The difference between the process in FIG. 8 and the process in FIG. 6 is also the entire detection manner of the control circuit 120. In the process in FIG. 8, the control circuit 120 finishes detecting the touched point on the touch panel 110 in the entire detection manner through Steps S810 to S860. In Step S810, the control circuit 120 first performs even-numbered entire detection of X, that is, the control circuit 120 detects signals of the first channels X2, X4, X6, X8, and X10 in sequence. Subsequently, in Step S820, the control circuit 120 determines whether the touch panel 110 is touched or not based on the signals of the first channels X2, X4, X6, X8, and X10. Next, in Step S830, the control circuit 120 performs odd-numbered entire detection of X, that is, the control circuit 120 detects signals of the first channels X1, X3, X5, X7, and X9 in sequence. Subsequently, in Step S840, the control circuit 120 determines whether the touch panel 110 is touched or not based on the signals of the first channels X1, X3, X5, X7, and X9. Subsequently, in Step S850, the control circuit 120 first performs entire detection of Y, that is, the control circuit 120 detects signals of the second channels Y1 to Y16 in sequence. Subsequently, in Step S860, the control circuit 120 determines whether the touch panel 110 is touched or not based on the signals of the second channels Y1 to Y16. In other words, in this embodiment, when detecting the touched point on the touch panel 110 in an entire detection manner, the control circuit 120 determines whether the touch panel 110 is touched or not through a first group of the first channels X1 to X10 (for example, the first channels X2, X4, X6, X8, and X10), a second group of the first channels X1 to X10 (for example, the first channels X1, X3, X5, X7, and X9), and all the second channels Y1 to Y16 in sequence, so as to detect the first touched point 512. The first channels in the first group (X2, X4, X6, X8, and X10) are parallel to and interleaved with the first channels in the second group (X1, X3, X5, X7, and X9). Subsequently, the control circuit 120 finishes detecting the touched point on the touch panel 110 in the area detection manner through Steps S630 to S650. In this embodiment, when the control circuit 120 detects the touched point on the touch panel 110 in an area detection manner, the control circuit 120 detects the touched point on the touch panel 110 through a part of the first channels adjacent to the first touched point 512 (for example, the first channels X3 to X7) and a part of the second channels adjacent to the first touched point 512 (for example, the second channels Y4 to Y8).

In the process in FIG. 8, Steps S810 and S820 are first executed, and then Steps S830 and S840 are performed. The first channels in the first group are even-numbered channels (X2, X4, X6, X8, and X10) and the first channels in the second group are odd-numbered channels (X1, X3, X5, X7, and X9). In another embodiment of the present invention, Steps S830 and S840 are first executed and Steps S810 and S820 are then executed. The first channels in the first group are odd-numbered channels (X1, X3, X5, X7, and X9) and the first channels in the second group are even-numbered channels (X2, X4, X6, X8, and X10). In other words, in this embodiment, when detecting the touched point on the touch panel 110 in the entire detection manner, the control circuit 120 determines whether the touch panel 110 is touched or not through a first group of the first channels X1 to X10 (for example, the odd-numbered channels X1, X3, X5, X7, and X9), a second group of the first channels X1 to X10 (for example, the even-numbered channels X2, X4, X6, X8, and X10), and all the second channels Y1 to Y16 in sequence, so as to detect the first touched point 512.

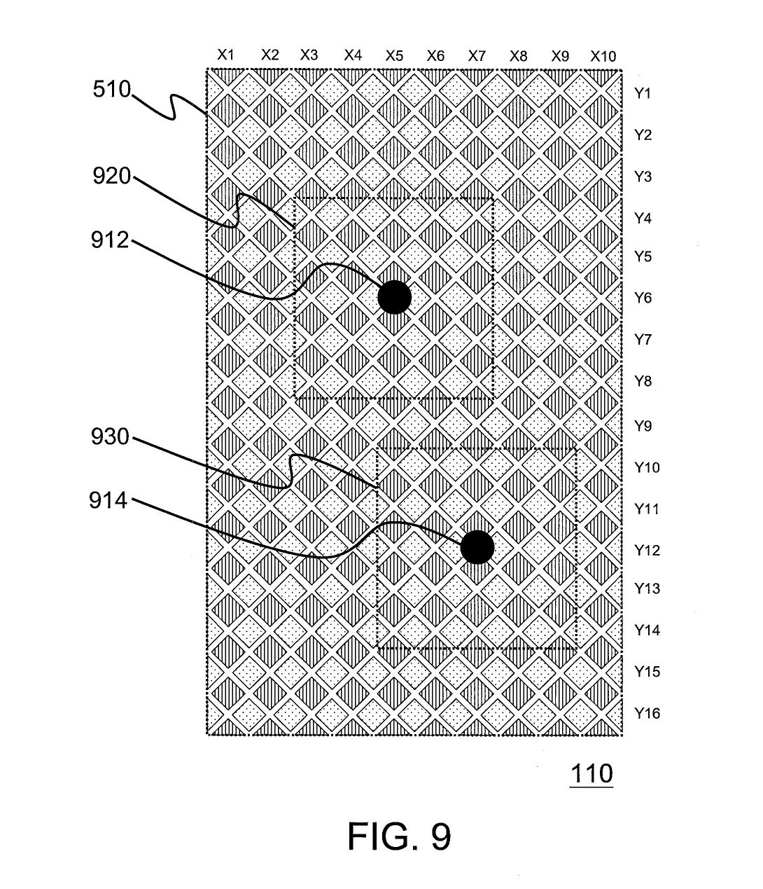

In addition to being used for detecting a single touched point, the present invention is also applicable to detection of a plurality of touched points. Please refer to FIG. 1 and FIG. 9. FIG. 9 illustrates a method for controlling a touch panel 110 according to an embodiment of the present invention. First, the control circuit 120 first detects the touched points on the touch panel 110 in an entire detection manner, that is, the control circuit 120 first detects the touched points within the entire detection area 510 on the touch panel 110, until a first touched point 912 and a second touched point 914 are detected within the entire area 510. After the control circuit 120 detects that the first touched point 912 and the second touched point 914, the control circuit 120 narrows the ranges of detecting the touched points on the touch panel 110 and switches to an area detection manner to detect the touched points on the touch panel 110, so as to detect the touched points within the first local detection area 920 and the second local detection area 930 on the touch panel 110. The entire detection area 510 comprises and is greater than a first local detection area 920 and a second local detection area 930.

In particular, in an embodiment of the present invention, when the control circuit 120 detects a plurality of touched points on the touch panel 110 in an entire detection manner, the control circuit 120 turns on the first channels X1 to X10 and the second channels Y1 to Y16 in sequence, until the first touched point 912 and the second touched point 914 on the touch panel 110 are detected. After the control circuit 120 detects the first touched point 912 and the second touched point 914, the control circuit 120 switches to an area detection manner to detect the touched points on the touch panel 110, that is, the control circuit 120 only utilizes a part of the first channels and a part of the second channels to detect the touched points on the touch panel 110. In this embodiment, when the control circuit 120 detects the touched points on the touch panel 110 in an area detection manner, the control circuit 120 detects the touched points on the touch panel 110 within the first local detection area 920 and the second local detection area 930, the first touched point 912 is located within the first local detection area 920, and the second touched point 914 is located within the second local detection area 930.

In an embodiment of the present invention, the range of the first local detection area 920 can be decided based on the first touched point 912, and the range of the second local detection area 930 can be decided based on the second touched point 914. By taking FIG. 5 as an example, the position of the first touched point 912 is near a position where the first channel X5 and the second channel Y6 interlace with each other. The first local detection area 920 takes the first touched point 912 as a center, and the range is an area defined by the first channels X3 to X7 and the second channels Y4 to Y8. The position of the second touched point 914 is near the position where the first channel X7 and the second channel Y12 interlace with each other. The second local detection area 930 takes the second touched point 914 as a center, and the range thereof is an area defined by the first channels X5 to X9 and the second channels Y10 to Y14. Furthermore, after the control circuit 120 detects the first touched point 912 and the second touched point 914, the control circuit 120 detects a plurality of touched points on the touch panel 110 locally on the first local detection area 920 and on the second local detection area 930 through the first channels X3 to X9 and the second channels Y4 to Y8 and Y10 to Y14.

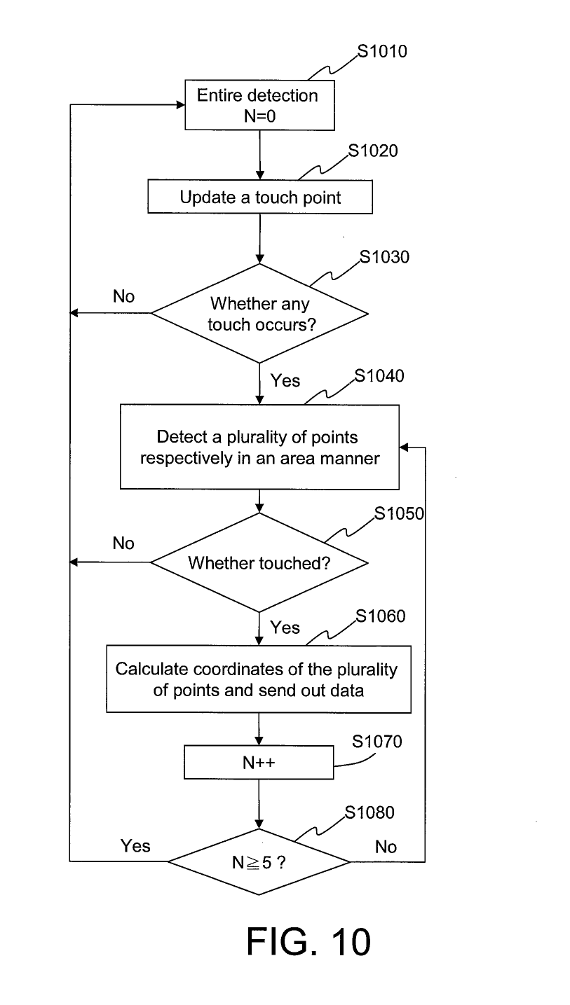

Please refer to FIG. 10, FIG. 1, and FIG. 9. FIG. 10 is a flow chart of a method for controlling a touch panel 110 according to an embodiment of the present invention. In Step S1010, the control circuit 120 detects the touched points on the touch panel 110 in an entire detection manner and makes the accumulated number of times of area detection N equal to 0. At this time, the control circuit 120 utilizes the first channels X1 to X10 and the second channels Y1 to Y16 to determine the touched points on the touch panel 110. In Step S1020, the control circuit 120, based on a detection result in Step S1010, updates information of the point. Furthermore, if the control circuit 120 detects in Step S1010 that a new detected point or the original first detected point already disappears, the latest touched point information is recorded. Next, in Step S1030, the control circuit 120 determines whether the touch panel 110 is touched or not. If in Step S1030, it is determined that the touch panel 110 is not touched, the process returns to Step S1010. Otherwise, if the control circuit 120 determines that the touch panel 110 is touched, Step S1040 is performed. In Step 1040, the control circuit 120 switches to an area detection manner to detect a plurality of touched points on the touch panel 110. For example, the control circuit 120 detects a movement of the first touched point 912 locally within the first local detection area 920 through the first channels X3 to X7 and the second channels Y4 to Y8, and detects a movement of the second touched point 914 locally within the second local detection area 930 through the first channels X5 to X9 and the second channels Y10 to Y14. In Step S1050, the control circuit 120 determines whether the touch panel 110 is touched or not. If in Step S1050, the touch panel 110 is not touched, the process returns to Step S1010. Otherwise, if the control circuit 120 determines that the touch panel 110 is touched, Step S1060 is performed to calculate coordinates of the touched points and send out the data. Subsequently, the control circuit 120 performs Step S1070 to add 1 to the accumulated number of times of area detection N. Next, the control circuit 120 performs Step S1080 to determine whether the accumulated number of times of area detection N is greater than or equal to the preset number of times. The preset number of times is, for example, 5. However, the present invention is not limited thereto. When the accumulated number of times of area detection N is equal to the preset number of times, it represents that the accumulated number of times that the control circuit 120 detects the touched points on the touch panel 110 in the area detection manner is already equal to the preset number of times. In this case, the control circuit 120 performs Step S1010, so as to detect the touched points on the touch panel 1010 again in the entire detection manner, that is, the control circuit 120 confirms whether a new touched point occurs within the entire detection area 510 by detecting all the entire area 510. Therefore, through the determination in Step S1080, the control circuit 120 then performs Step S1010 again to detect whether a new touched point occurs.

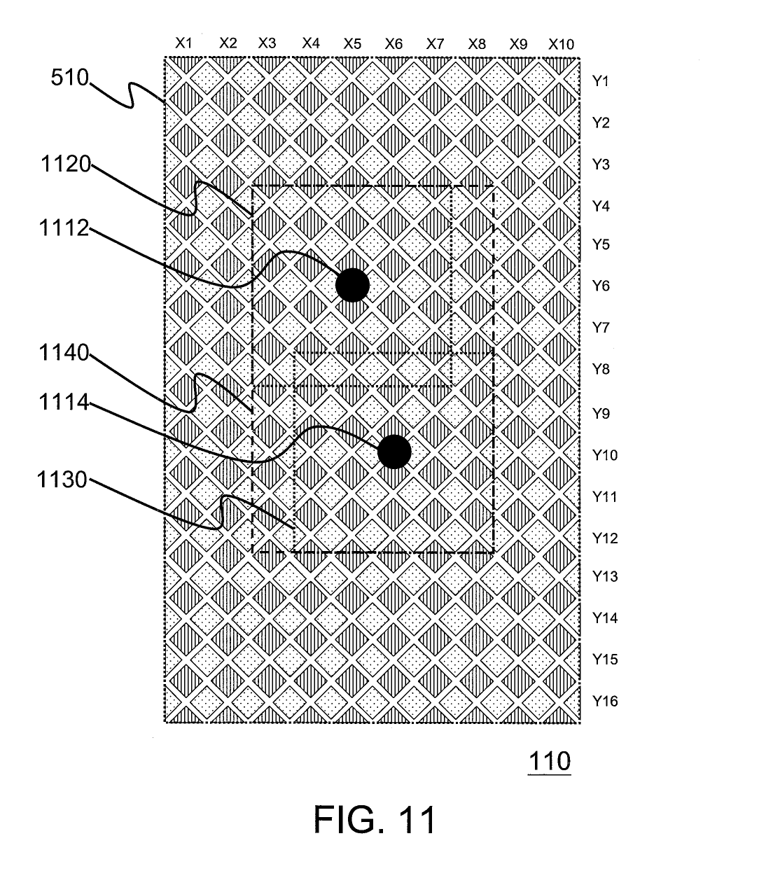

Please refer to FIG. 11 and FIG. 1. FIG. 11 illustrates a method for controlling the touch panel 110 according to an embodiment of the present invention. In this embodiment, the control circuit 120 can detect a plurality of touched points. First, the control circuit 120 first detects the touched points on the touch panel 110 in an entire detection manner, until a first touched point 1112 and a second touched point 1114 on the touch panel 110 are detected. After the control circuit 120 detects the first touched point 1112 and the second touched point 1114, the control circuit 120 switches to an area detection manner to detect the touched points on the touch panel 110. In this embodiment, the first touched point 1112 is a central point of the first local detection area 1120, and the second touched point 1114 is a central point of the second local detection area 1130, in which the first local detection area 1120 and the second local detection area 1130 partially overlap each other. When the control circuit 120 detects the touched points on the touch panel 110 in an area detection manner, the control circuit 120 uses a third local detection area 1140 as the detection range thereof to detect a plurality of touched points on the touch panel 110. The third local detection area 1140 is smaller than the entire detection area 510 of the touch panel 110, the third local detection area 1140 covers the first local detection area 1120 and the second local detection area 1130, and the first touched point 1112 and the second touched point 1114 are located within the third local detection area 1140.

In an embodiment of the present invention, a used density of the first channels X1 to X10 and the second channels Y1 to Y16 within the entire detection area is smaller than a used density of the first channels X1 to X10 and the second channels Y1 to Y16 within the local detection area. The used density is defined as the channel number that the first channels X1 to X10 and the second channels Y1 to Y16 are used within a unit area. In other words, when the control circuit 120 detects the touched points on the touch panel 110 in the entire detection manner, the used density corresponding to the used channels of the first channels X1 to X10 and the second channels Y1 to Y16 is relatively low. When the control circuit 120 detects the touched points on the touch panel 110 in the area detection manner, the used density corresponding to the used channels of the first channels X1 to X10 and the second channels Y1 to Y16 is relatively high. FIG. 5 is used for illustration. In an embodiment of the present invention, when the control circuit 120 detects the touched points on the touch panel 110 in an entire detection manner, the control circuit 120 detects the touched points within the entire detection area 510, and the used channels are the first channels X1, X3, X5, X7, and X9 and the second channels Y1, Y3, Y5, Y7, Y9, Y11, Y13, Y15. When the control circuit 120 detects the touched points on the touch panel 110 in an area detection manner, the control circuit 120 detects the touched points within the first local detection area 520, and the used channels are the first channels X3 to X7 and the second channels Y4 to Y8. Therefore, within the first local detection area 520, the used density of the first channels X1 to X10 and the second channels Y1 to Y16 is equal to four times of the used density of the first channels and second channels within the entire detection area 510. In other words, in this embodiment, the control circuit 120 performs the entire detection at a relatively low used density and performs area detection in a relatively high used density.

It should be noted that the case of the used density of the channels is also applicable to a multi-touch situation. Taking FIG. 9 as an example, the used density of the first channels X1 to X10 and the second channels Y1 to Y16 within the entire detection area 510 is smaller than the used densities of the first channels X1 to X10 and the second channels Y1 to Y16 within the first local detection area 920 and the second local detection area 930. In particular, when the control circuit 120 detects the touched points on the touch panel 110 in an entire detection manner, the control circuit 120 detects the touched points within the entire detection area 510, and the used channels are the first channels X1, X3, X5, X7, and X9 and the second channels Y1, Y3, Y5, Y7, Y9, Y11, Y13, and Y15. When the control circuit 120 detects the touched points on the touch panel 110 in an area detection manner, the control circuit 120 detects the touched point within the first local detection area 920 and the second local detection area 930, and the used channels are the first channels X3 to X9 and the second channels Y4 to Y8 and Y10 to Y14. Therefore, the used densities of the first channels X1 to X10 and the second channels Y1 to Y16 within the first local detection area 920 and the second local detection area 930 are equal to four times of the used density of the first channels and second channels within the entire detection area 510.

In conclusion, in the method for controlling a touch panel according to the embodiment, after the first touched point is detected, a range of detecting the touched point on the touch panel is narrowed, so as to detect the touched point within a local detection area on the touch panel. Accordingly, when the touched point on the touch panel is detected in an area detection manner, the number of the used channels can be reduced, so as to further enhance the efficiency of detecting the touched point.

The present invention has been disclosed through the embodiments above, but is not intended to be limited thereto. Various variations and modifications made by persons of ordinary skills in the art without departing from the spirit and scope of the present invention shall fall within the protection scope of the present invention as defined by the appended claims.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for controlling a touch panel, comprising:
detecting a touched point within an entire detection area on the touch panel, until a first touched point is detected within the entire area; and
after the first touched point is detected, narrowing a range of detecting the touched point on the touch panel, so as to detect the touched point within a local detection area on the touch panel;
wherein the entire detection area comprises and is greater than the local detection area.

2. The method for controlling a touch panel according to claim 1, wherein the touch panel comprises a plurality of first channels and a plurality of second channels, the first channels interlace with the second channels;
when the touched point within the entire detection area is being detected, the first touched point is detected through all the first channels and all the second channels;
when the touched point within the local detection area is being detected, the touched point on the touch panel is detected through a part of the first channels and a part of the second channels adjacent to the first touched point.

3. The method for controlling a touch panel according to claim 1, wherein the touch panel comprises a plurality of first channels and a plurality of second channels, the first channels interlace with the second channels;
when the touched point within the entire detection area is being detected, it is first determined whether the touch panel is touched or not through all the first channels, and then it is determined whether the touch panel is touched or not through all the second channels, so as to detect the first touched point; and
when the touched point within the local detection area is being detected, the touched point on the touch panel is detected through a part of the first channels and a part of the second channels adjacent to the first touched point.

4. The method for controlling a touch panel according to claim 1, wherein the touch panel comprises a plurality of first channels and a plurality of second channels, the first channels interlace with the second channels;
when the touched point within the entire detection area is being detected, it is determined whether the touch panel is touched or not through a first group of the first channels, a second group of the first channels, and all the second channels in sequence, so as to detect the first touched point, wherein the first channels in the first group are parallel to and interleaved with the first channels in the second group;
when the touched point within the local detection area is being detected, the touched point on the touch panel is detected through a part of the first channels and a part of the second channels adjacent to the first touched point.

5. The method for controlling a touch panel according to claim 4, wherein the first channels in the first group are even-numbered channels of the first channels and the first channels in the second group are odd-numbered channels of the first channels.

6. The method for controlling a touch panel according to claim 4, wherein the first channels in the first group are odd-numbered channels of the first channels and the first channels in the second group are even-numbered channels of the first channels.

7. The method for controlling a touch panel according to claim 1, wherein the first touched point is located within the local detection area.

8. The method for controlling a touch panel according to claim 1, wherein the touch panel comprises a plurality of first channels and a plurality of second channels, the first channels interlace with the second channels, and a used density of the first channels and the second channels within the entire detection area is smaller than a used density of the first channels and the second channels within the local detection area.

9. A method for controlling a touch panel, comprising:
detecting a touched point within an entire detection area on the touch panel, until a first touched point and a second touched point are detected within the entire area; and
after the first touched point and the second touched point are detected, narrowing ranges of detecting the touched points on the touch panel, so as to detect the touched points within a first local detection area and a second local detection area on the touch panel;
wherein the entire detection area comprises and is greater than the first local detection area and the second local detection area.

10. The method for controlling a touch panel according to claim 9, wherein the first touched point is located within the first local detection area and the second touched point is located within the second local detection area.

11. The method for controlling a touch panel according to claim 9, wherein the touch panel comprises a plurality of first channels and a plurality of second channels, the first channels interlace with the second channels, and a used density of the first channels and the second channels within the entire detection area are smaller than used densities of the first channels and the second channels within the first local detection area and the second local detection area.

12. The method for controlling a touch panel according to claim 9, wherein when the touched points within the first local detection area and the second local detection area are being detected, the touched points on the touch panel are detected through a part of the first channels and a part of the second channels adjacent to the first touched point and the second touched point.

13. The method for controlling a touch panel according to claim 9, further comprising:
when the accumulated number of times of detecting the touched points within the first local detection area and the second local detection area is equal to a preset number of times, it is confirmed whether a new touched point occurs within the entire detection area by detecting all of the entire area.
